(19) United States
(12) Patent Application Publication
(10) Pub. No.: US 2017/0016607 A1
(43) Pub. Date: Jan. 19, 2017

(54) Light Emitting Module

(71) Applicant: KONICA MINOLTA, INC., Tokyo (JP)

(72) Inventor: Masatoshi YONEYAMA, Izumi-shi (JP)

(21) Appl. No.: 15/122,013

(22) PCT Filed: Mar. 10, 2015
(86) PCT No.: PCT/JP2015/056905

§ 371 Date: Aug. 26, 2016

(30) Foreign Application Priority Data
Mar. 18, 2014 (JP) 2014-055019

(51) Int. Cl. F21V 29/50; F21V 23/02

(52) U.S. Cl. CPC F21V 29/50; F21V 23/02; F21Y 2115/15

(57) ABSTRACT

A light emitting module includes a light emitting unit including a planar light-emitting element, and a power supply that is connected in series to the light emitting unit and supplies constant current to the light emitting unit. The power supply includes two or more constant-current power supplies, and the two or more constant-current power supplies are connected in parallel.

### TECHNICAL FIELD

The present invention relates to a light emitting module that includes constant-current power supplies.

### BACKGROUND ART

JP 2013-131296 A (Patent Literature 1) discloses an invention relating to an LED (Light Emitting Diode) lighting device. This LED lighting device includes LED elements connected in series, and a single constant-current power supply that is connected in series to the LED elements and supplies constant current. The constant-current power supply includes a switching element, a diode, and a coil. At least one element among the switching element, the diode, and the coil is divided into two or more elements to be mounted on the device.

In a case where the current to be applied to the LED elements becomes large, the switching element, the diode, and the coil generate heat, and the temperature of the constant-current power supply rises. As at least one element among the switching element, the diode, and the coil is divided into two or more elements to be mounted on the device, the heat generating portions are scattered inside the constant-current power supply, and the temperature can be prevented from becoming higher than a certain degree.

### CITATION LIST

### Patent Literature

Patent Literature 1: JP 2013-131296 A

### SUMMARY OF INVENTION

### Technical Problem

A light emitting module including a planar light-emitting element using an organic EL (Electro Luminescence) or the like has recently been developed. A planar light-emitting element has a larger area than a constant-current power supply. Even in a case where the constant-current power supply disclosed in Patent Literature 1 is used, when the temperature of the constant-current power supply rises, temperature also rises in the portions of the planar light-emitting element located close to the constant-current power supply. As a result, temperature variation is caused in the planar light-emitting element. In a case where a single constant-current power supply is used for two or more planar light-emitting elements, the temperatures of the planar light-emitting elements located close to the constant-current power supply rise, and the planar light-emitting elements have different temperatures.

In a case where such an in-plane temperature variation is caused, the luminance in light emission becomes higher in the high-temperature portions, and luminance unevenness occurs in the light emitting module.

The present invention has been made in view of the above problems, and the present invention aims to provide a light emitting module that can reduce in-plane temperature variation and luminance unevenness.

### Solution to Problem

A light emitting module according to the present invention includes: a light emitting unit including a planar light-emitting element; and a power supply that are connected in series to the light emitting unit and supplies constant current to the light emitting unit. In the light emitting module, the power supply includes two or more constant-current power supplies, and the two or more constant-current power supplies are connected in parallel.

In the light emitting module according to the present invention, the light emitting unit preferably includes planar light-emitting elements, and the planar light-emitting elements are preferably connected in series.

The light emitting module according to the present invention may include light emitting units. In this case, the light emitting units are preferably connected in parallel.

The light emitting module according to the present invention preferably further includes a holding member that holds the planar light-emitting element, and the power supply is preferably disposed on the holding member.

In the light emitting module according to the present invention, when seen from the normal direction of the principal surface of the holding member on which the planar light-emitting element is held, the constant-current power supplies are positioned to overlap a no-light emitting portion surrounding the planar light-emitting element.

In the light emitting module according to the present invention, the constant-current power supplies are preferably scattered around the planar light-emitting element.

In the light emitting module according to the present invention, on the principal surface of the holding member on the opposite side from the principal surface of the holding member on which the planar light-emitting element is held, the constant-current power supplies are disposed in portions on the opposite side from the planar light-emitting element.

In the light emitting module according to the present invention, the constant-current supplies are preferably scattered on the principal surface of the holding member.

In the light emitting module according to the present invention, when seen from the normal direction of the principal surface of the holding member on which the planar light-emitting element is held, the constant-current power supplies are positioned to overlap portions of the no-light emitting portion surrounding the planar light-emitting elements, the portions excluding the gaps between the planar light-emitting elements adjacent to each other.

In the light emitting module according to the present invention, the holding member may include a base unit that holds the planar light-emitting element, and a wiring substrate disposed on a principal surface of the base unit. In this case, when seen from the normal direction of the principal surface of the holding member on which the planar light-emitting elements are held, the wiring substrate is preferably disposed in a portion of the no-light emitting portion surrounding the planar light-emitting elements, the portion excluding gaps between the planar light-emitting elements adjacent to each other, and the constant-current power supplies are preferably disposed on the wiring substrate.

In the light emitting module according to the present invention, the planar light-emitting element is preferably an organic EL.

### Advantageous Effects of Invention

According to the present invention, it is possible to provide a light emitting module that can reduce in-plane temperature variation and luminance unevenness in the light emitting module.

### BRIEF DESCRIPTION OF DRAWINGS

FIG. 1 is a schematic plan view of a light emitting module according to a comparative example.

FIG. 2 is a schematic cross-sectional view, taken along the II-II line defined in FIG. 1.

FIG. 3 is a circuit diagram showing the circuit configuration of the light emitting module shown in FIG. 1.

FIG. 4 is a schematic plan view of a light emitting module according to a first embodiment of the present invention.

FIG. 5 is a schematic cross-sectional view, taken along the V-V line defined in FIG. 4.

FIG. 6 is a circuit diagram showing the circuit configuration of the light emitting module shown in FIG. 4.

FIG. 7 is a schematic plan view of a light emitting module according to a second embodiment of the present invention.

FIG. 8 is a schematic cross-sectional view, taken along the VIII-VIII line defined in FIG. 7.

FIG. 9 is a schematic plan view of a light emitting module according to a third embodiment of the present invention.

FIG. 10 is a schematic cross-sectional view, taken along the X-X line defined in FIG. 9.

FIG. 11 is a schematic plan view of a light emitting module according to a fourth embodiment of the present invention.

FIG. 12 is a circuit diagram showing the circuit configuration of the light emitting module shown in FIG. 11.

FIG. 13 is a circuit diagram showing the circuit configuration of a light emitting module according to a first modification.

FIG. 14 is a circuit diagram showing the circuit configuration of a light emitting module according to a second modification.

### DESCRIPTION OF EMBODIMENTS

The following is a detailed description of a comparative example and embodiments of the present invention, with reference to the accompanying drawings. In the comparative example and the embodiments described below, like or common components are denoted by like reference numerals in the drawings, and explanation thereof will not be repeated. In the comparative example and the embodiments described below, the numbers, the amounts, and the like mentioned below do not limit the scope of the invention, unless otherwise specified. If two or more embodiments are described below, it should be understood that the characteristic aspects of the embodiments are to be combined as appropriate, unless otherwise specified.

### COMPARATIVE EXAMPLE

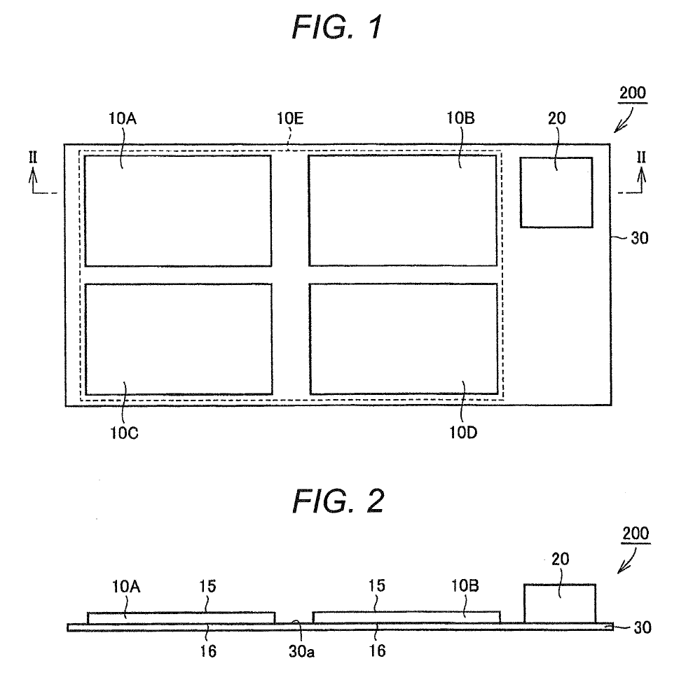

FIG. 1 is a schematic plan view of a light emitting module according to a comparative example. FIG. 2 is a schematic cross-sectional view, taken along the II-II line defined in FIG. 1. Referring now to FIGS. 1 and 2, the light emitting module according to the comparative example is described.

As shown in FIGS. 1 and 2, the light emitting module 200 according to the comparative example includes a light emitting unit 10E, a constant-current power supply 20, and a holding member 30.

The light emitting unit 10E includes four planar light-emitting elements 10A, 10B, 10C, and 10D. The planar light-emitting elements 10A, 10B, 10C, and 10D are arranged in a 2×2 matrix fashion, and are positioned in a plane (the same plane) in a surface direction. The four planar light-emitting elements 10A, 10B, 10C, and 10D each have a rectangular shape. The planar light-emitting elements 10A, 10B, 10C, and 10D are formed with planar organic ELs or the like. The planar light-emitting elements 10A, 10B, 10C, and 10D each include a front surface 15 and aback surface 16, and emit light from the side of the front surface 15. The planar light-emitting elements 10A, 10B, 10C, and 10D are electrically connected by wiring lines or the like.

The holding member 30 holds the planar light-emitting elements 10A, 10B, 10C, and 10D from the side of the back surface 16 of each planar light-emitting element. The holding member 30 is formed with a wiring substrate. The constant-current power supply 20 is provided on the opposite side of the planar light-emitting element 10B from the planar light-emitting element 10A. The constant-current power supply 20 is provided on the principal surface 30a of the holding member 30 on which the planar light-emitting elements are held. The constant-current power supply 20 is electrically connected to the light emitting unit 10E by a wiring pattern formed on the wiring substrate. The constant-current power supply 20 supplies constant current to the light emitting unit 10E.

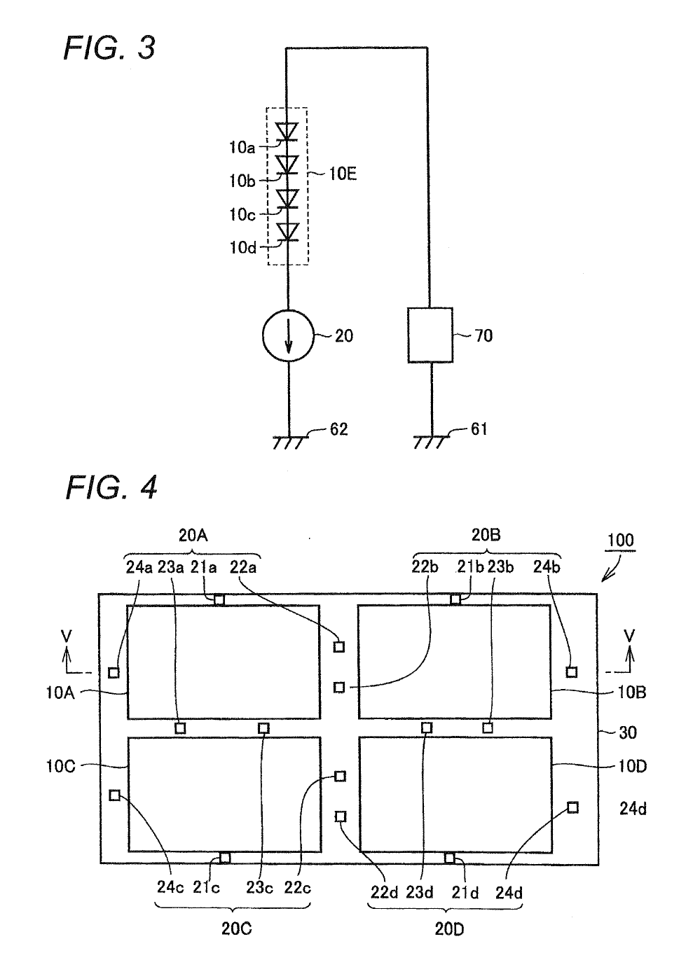

FIG. 3 is a circuit diagram showing the circuit configuration of the light emitting module shown in FIG. 1. Referring to FIG. 3, the circuit configuration of the light emitting module 200 according to the comparative example is described.

The light emitting module 200 includes a voltage source 70, the light emitting unit 10E, and the constant-current power supply 20. The voltage source 70 is connected between a ground potential 61 and the light emitting unit 10E. On the anode side of the light emitting unit 10E, the voltage source 70 is connected in series to the light emitting unit 10E. The light emitting unit 10E is a string formed with the planar light-emitting elements 10A, 10B, 10C, and 10D connected in series.

The constant-current power supply 20 is connected between a ground potential 62 and the light emitting unit 10E. On the cathode side of the light emitting unit 10E, the constant-current power supply 20 is connected in series to the light emitting unit 10E. The ground potential 61 and the ground potential 62 are the same potential. As such a circuit is formed, constant current flows in the light emitting unit 10E.

In this comparative example, however, the series-connected planar light-emitting elements 10A, 10B, 10C, and 10D are driven with constant current supplied from the single constant-current power supply 20, and therefore, the current to be controlled by the constant-current power supply 20 is large. As a result, the respective elements constituting the constant-current power supply 20 generate heat, and the temperature of the constant-current power supply 20 becomes higher.

The planar light-emitting element 10B is located in the vicinity of the constant-current power supply 20. Therefore, the temperature of the planar light-emitting element 10B rises easily, compared with the temperatures of the other planar light-emitting elements 10A, 10C, and 10D. In this case, the luminance of the planar light-emitting element 10B becomes higher than the luminances of the other planar light-emitting elements 10A, 10C, and 10D, and therefore, the luminances vary in the light emitting module 200. As a result, luminance unevenness appears. The embodiments described below can reduce such luminance unevenness.

### First Embodiment

FIG. 4 is a schematic plan view of a light emitting module according to this embodiment. FIG. 5 is a schematic cross-sectional view, taken along the V-V line defined in FIG. 4. Referring now to FIGS. 4 and 5, the light emitting module 100 according to this embodiment is described.

As shown in FIGS. 4 and 5, the light emitting module 100 according to this embodiment differs from the light emitting module 200 according to the comparative example in having power supplies 20A, 20B, 20C, and 20D including constant-current power supplies, and in the later described circuit configuration. The other aspects are substantially the same.

In a case where planar light-emitting elements 10A, 10B, 10C, and 10D are arranged in a matrix fashion, a no-light emitting portion R1 (see FIG. 5) that does not contribute to light emission is formed in the areas surrounding the planar light-emitting elements 10A, 10B, 10C, and 10D, including the gaps R2 (see FIG. 5) between the planar light-emitting elements adjacent to each another.

The power supplies 20A, 20B, 20C, and 20D include constant-current power supplies 21a through 24a, 21b through 24b, 21c through 24c, and 21d through 24d, respectively. These constant-current power supplies 21a through 24a, 21b through 24b, 21c through 24c, and 21d through 24d are disposed in the no-light emitting portion R1 on the holding member 30. The constant-current power supplies 21a through 24a, 21b through 24b, 21c through 24c, and 21d through 24d are also scattered on the holding member 30.

Specifically, the constant-current power supplies 21a through 24a are scattered in the areas surrounding the planar light-emitting element 10A. The constant-current power supplies 21a through 24a are positioned to face portions close to the centers of the respective rims of the planar light-emitting element 10A. Likewise, the constant-current power supplies 21b through 24b, 21c through 24c, and 21d through 24d are scattered in the areas surrounding thee planar light-emitting elements 10B, 10C, and 10D, and are positioned to face portions close to the centers of the respective rims of the planar light-emitting elements 10B, 10C, and 10D.

The constant-current power supplies 22a and 22b are disposed in the gap R2 between the planar light-emitting elements 10A and 10B adjacent to each other. The constant-current power supplies 23b and 23d are disposed in the gap R2 between the planar light-emitting elements 10B and 10D adjacent to each other. The constant-current power supplies 22c and 22d are disposed in the gap R2 between the planar light-emitting elements 10C and 10D adjacent to each other. The constant-current power supplies 23a and 23c are disposed in the gap R2 between the planar light-emitting elements 10A and 10C adjacent to each other.

In the example case illustrated in FIGS. 4 and 5, the constant-current power supplies 21a through 24a, 21b through 24b, 21c through 24c, and 21d through 24d are disposed on the principal surface 30a of the holding member 30 on which the planar light-emitting elements are held. However, the embodiment is not limited to that, and the constant-current power supplies 21a through 24a, 21b through 24b, 21c through 24c, and 21d through 24d may be disposed on the principal surface 30b on the opposite side from the principal surface 30a. That is, when seen from the normal direction of the principal surface 30a of the holding member 30, the constant-current power supplies 21a through 24a, 21b through 24b, 21c through 24c, and 21d through 24d should be positioned to overlap the no-light emitting portion R1 located in the areas surrounding the planar light-emitting elements 10A, 10B, 10C, and 10D.

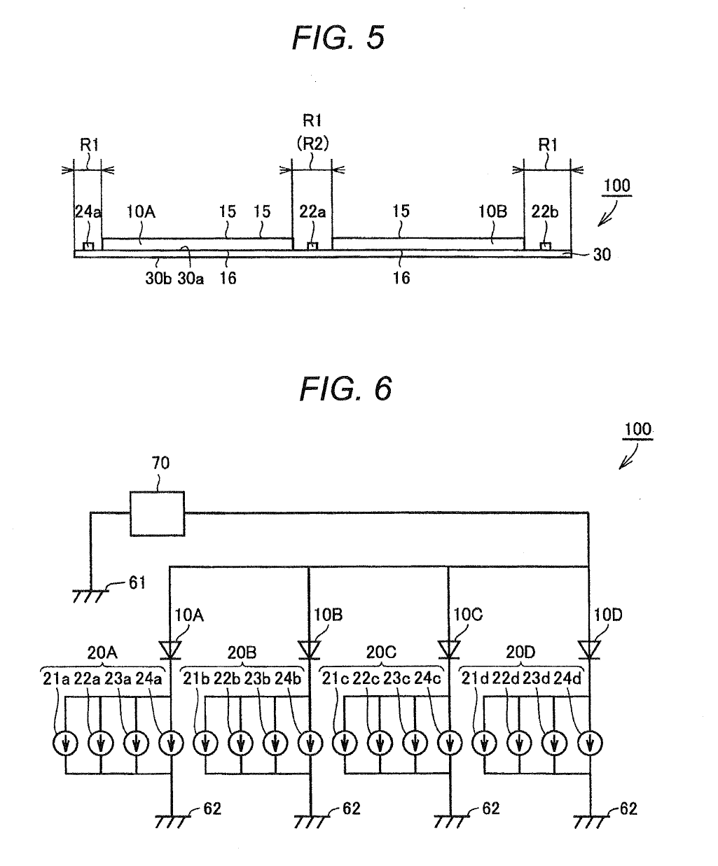

FIG. 6 is a circuit diagram showing the circuit configuration of the light emitting module shown in FIG. 4. Referring now to FIG. 6, the circuit configuration of the light emitting module 100 according to this embodiment is described.

In the light emitting module 100, each of the planar light-emitting elements 10A, 10B, 10C, and 10D is connected to the voltage source 70. The planar light-emitting elements 10A, 10B, 10C, and 10D are connected in parallel. In this embodiment, each of the planar light-emitting elements 10A, 10B, 10C, and 10D is equivalent to a light emitting unit.

The power supplies 20A, 20B, 20C, and 20D are connected in series to the planar light-emitting elements 10A, 10B, 10C, and 10D, respectively. The power supplies 20A, 20B, 20C, and 20D are connected to the anode sides of the planar light-emitting elements 10A, 10B, 10C, and 10D. In the respective power supplies 20A, 20B, 20C, and 20D, the constant-current power supplies 21a through 24a, 21b through 24b, 21c through 24c, and 21d through 24d are connected in parallel. The constant-current power supplies 21a through 24a, 21b through 24b, 21c through 24c, and 21d through 24d are connected to the cathode sides of the planar light-emitting elements 10A, 10B, 10C, and 10D.

As such a circuit is formed, constant current flows in each of the planar light-emitting elements 10A, 10B, 10C, and 10D. In this embodiment, the planar light-emitting elements 10A, 10B, 10C, and 10D connected in parallel are driven with constant current supplied from the scattered constant-current power supplies 21a through 24a, 21b through 24b, 21c through 24c, and 21d through 24d.

Therefore, the load on each of the constant-current power supplies 21a through 24a, 21b through 24b, 21c through 24c, and 21d through 24d according to this embodiment is smaller than the load on the constant-current power supply 20 according to the comparative example. For example, if the voltage to be applied to the light emitting unit 10E is 28 V in the comparative example, the voltage to be applied to each of the planar light-emitting elements 10A, 10B, 10C, and 10D according to this embodiment is 7 V. Thus, the current to flow in the constant-current power supplies can be made smaller. As a result, heat generation from the constant-current power supplies 21a through 24a, 21b through 24b, 21c through 24c, and 21d through 24d can be reduced.

As the constant-current power supplies 21a through 24a, 21b through 24b, 21c through 24c, and 21d through 24d are scattered, temperature variation among the planar light-emitting elements 10A, 10B, 10C, and 10D can be reduced. Thus, luminance variation in the light emitting module 100 can be reduced.

As the constant-current power supplies 21a through 24a, 21b through 24b, 21c through 24c, and 21d through 24d are scattered almost evenly in the areas surrounding the planar light-emitting elements 10A, 10B, 10C, and 10D, temperature variation in each single planar light-emitting element can also be reduced. Thus, luminance unevenness can be further reduced.

As the planar light-emitting elements 10A, 10B, 10C, and 10D are connected in parallel, the withstand voltage of each of the constant-current power supplies 21a through 24a, 21b through 24b, 21c through 24c, and 21d through 24d can be made lower than that in the comparative example. Thus, each of the constant-current power supplies 21a through 24a, 21b through 24b, 21c through 24c, and 21d through 24d can be made smaller and thinner. As a result, the light emitting module 100 can also be made smaller and thinner.

### Second Embodiment

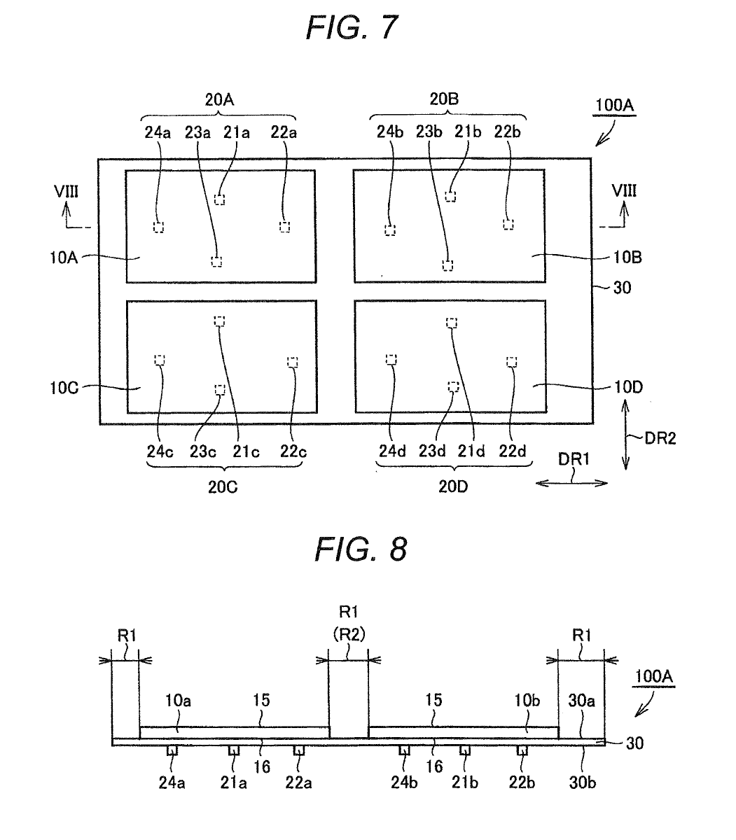

FIG. 7 is a schematic plan view of a light emitting module according to this embodiment. FIG. 8 is a schematic cross-sectional view, taken along the VIII-VIII line defined in FIG. 7. Referring now to FIGS. 7 and 8, the light emitting module 100A according to this embodiment is described.

As shown in FIGS. 7 and 8, the light emitting module 100A according to this embodiment differs from the light emitting module 100 according to the first embodiment in the positions in which the power supplies (constant-current power supplies) are disposed. The other aspects, including the circuit configuration, are substantially the same.

On a principal surface 30b (see FIG. 8) located on the opposite side of a holding member 30 from a principal surface 30a of the holding member 30 holding planar light-emitting elements 10A, 10B, 10C, and 10D, constant-current power supplies 21a through 24a, 21b through 24b, 21c through 24c, and 21d through 24d included in power supplies 20A, 20B, 20C, and 20D are disposed in portions on the opposite side from the planar light-emitting elements 10A, 10B, 10C, and 10D.

The constant-current power supplies 21a through 24a are evenly scattered in the portion on the principal surface 30b on the opposite side from the planar light-emitting element 10A. Specifically, the constant-current power supplies 21a and 23a are at a predetermined distance from each other, and are aligned in the short direction (a direction DR2 in FIG. 7) of the planar light-emitting element. The constant-current power supplies 21a and 23a are positioned to face the central portion in the longitudinal direction (a direction DR1 in FIG. 7) of the planar light-emitting element 10A. The constant-current power supplies 22a and 24a are at a predetermined distance from each other, and are aligned in the longitudinal direction of the planar light-emitting element. The constant-current power supplies 22a and 24a are positioned to face the central portion in the short direction of the planar light-emitting element 10A.

The constant-current power supplies 21b through 24b, 21c through 24c, and 21d through 24d are also positioned to have the same positional relationships with the planar light-emitting elements 10B, 10C, and 10D, as the positional relationships between the constant-current power supplies 21a through 24a and the planar light-emitting element A.

In such a configuration, substantially the same effects as those of the first embodiment can be achieved. Also, the constant-current power supplies 21a through 24a, 21b through 24b, 21c through 24c, and 21d through 24d are disposed in the portions on the principal surface 30b on the opposite side of the holding member 30 from the planar light-emitting elements 10A, 10B, 10C, and 10D, respectively, so that the gaps between the planar light-emitting elements adjacent to each other can be narrowed. The gaps R2 formed between the planar light-emitting elements do not contribute to light emission. Therefore, as the gaps become narrower, the luminance unevenness to be caused by the joints between the planar light-emitting elements can be reduced.

The positions in which the constant-current power supplies 21a through 24a, 21b through 24b, 21c through 24c, and 21d through 24d are disposed are not limited to the above, but may be appropriately changed within the portions on the principal surface 30b on the opposite side of the holding member 30 from the planar light-emitting elements 10A, 10B, 10C, and 10D, as long as temperature variation among the planar light-emitting elements can be reduced.

### Third Embodiment

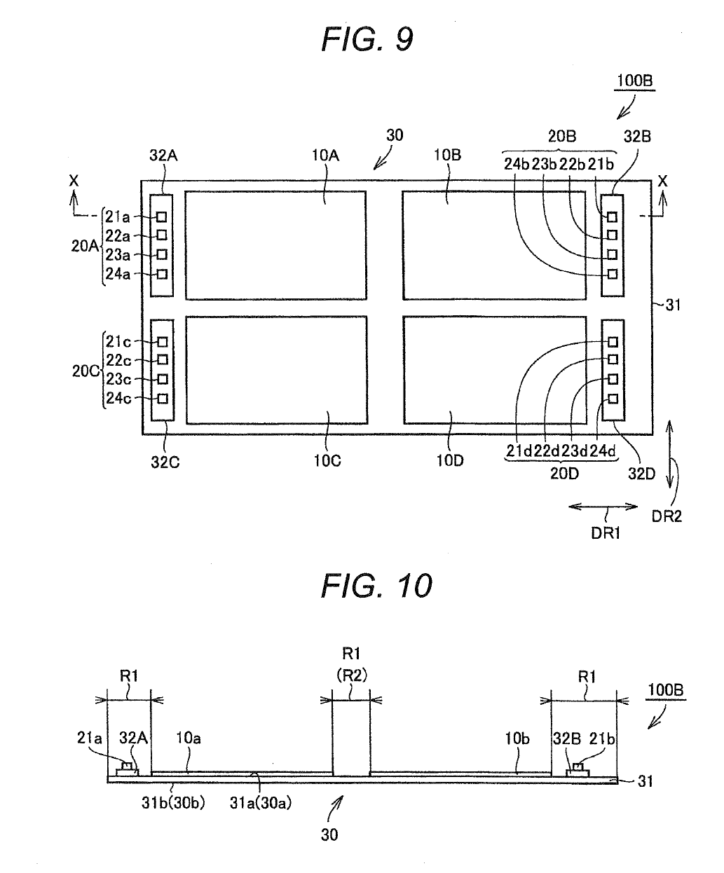

FIG. 9 is a schematic plan view of a light emitting module according to this embodiment. FIG. 10 is a schematic cross-sectional view, taken along the X-X line defined in FIG. 9. Referring now to FIGS. 9 and 10, the light emitting module 100B according to this embodiment is described.

As shown in FIGS. 9 and 10, the light emitting module 100B according to this embodiment differs from the light emitting module 100 according to the first embodiment in the structure of the holding member 30 and the positions in which the power supplies (constant-current power supplies) are disposed. The other aspects, including the circuit configuration, are substantially the same.

The holding member 30 includes a base unit 31 and wiring substrates 32A, 32B, 32C, and 32D. The base unit 31 has a sheet-like shape. The base unit 31 may be formed with a flexible, transparent resin film, such as a PET (polyethylene terephthalate) film, a PEN (polyethylene naphthalate) film, a PC (poly carbonate) film, or a PMMA (polymethyl methacrylate) film, for example.

The base unit 31 may be designed not to have translucency, and may be a film formed by stacking a film of a metal, such as aluminum, and a resin film, for example. The base unit 31 is not necessarily formed with the above transparent resin film, but may be formed with an inflexible housing or the like made of a metal, such as AL (aluminum) or SUS (stainless steel).

The base unit 31 holds the planar light-emitting elements 10A, 10B, 10C, and 10D from the side of the back surface 16 of each planar light-emitting element. The wiring substrates 32A, 32B, 32C, and 32D are disposed on the principal surface 31a of the base unit on which the planar light-emitting elements are held. The wiring substrates 32A, 32B, 32C, and 32D are disposed in portions of a no-light emitting portion R1 surrounding the planar light-emitting elements 10A, 10B, 10C, and 10D, except for the gaps R2 between the planar light-emitting elements adjacent to each other.

The wiring substrates 32A and 32B are positioned on the opposite side from each other, with the planar light-emitting elements 10A and 10B being interposed in between. The wiring substrates 32C and 32D are positioned on the opposite side from each other, with the planar light-emitting elements 10A and 10B being interposed in between. The wiring substrates 32A and 32B are aligned in the short direction (a direction DR2 in FIG. 9) of the planar light-emitting elements 10A and 10B. The wiring substrates 32C and 32D are aligned in the short direction of the planar light-emitting elements 10C and 10D.

The constant-current power supplies 21a through 24a, 21b through 24b, 21c through 24c, and 21d through 24d are disposed on the holding member 30, and more specifically, are disposed on the wiring substrates 32A, 32B, 32C, and 32D. The constant-current power supplies 21a through 24a and 21b through 24b are aligned in the short direction of the planar light-emitting elements 10A and 10B. The constant-current power supplies 21c through 24c and 21d through 24d are aligned in the short direction of the planar light-emitting elements 10C and 10D.

In a case where such a configuration is formed, the load on each of the constant-current power supplies 21a through 24a, 21b through 24b, 21c through 24c, and 21d through 24d can be reduced, and heat generation from these constant-current power supplies can be reduced. Temperature variation among the planar light-emitting elements 10A, 10B, 10C, and 10D can be reduced. Thus, luminance variation in the light emitting module 100 can be reduced.

The wiring substrates 32A, 32B, 32C, and 32D, and the constant-current power supplies 21a through 24a, 21b through 24b, 21c through 24c, and 21d through 24d are disposed in the portions of the no-light emitting portion R1, except for the gaps R2 between the planar light-emitting elements adjacent to each other. With this, the gaps between the planar light-emitting elements adjacent to each other can be narrowed.

Thus, luminance unevenness to be caused by the joints between the planar light-emitting elements can be reduced.

Furthermore, the areas of the wiring substrates 32A, 32B, 32C, and 32D are smaller than the holding member 30 according to the first embodiment. Thus, the production costs can be lowered.

In the example case described in this embodiment, the wiring substrates 32A and 32B, and the wiring substrates 32C and 32D are aligned in the short direction of the planar light-emitting elements. However, the embodiment is not limited to that, and the wiring substrates 32A and 32B, and the wiring substrates 32C and 32D may be aligned in the longitudinal direction (the direction DR1 in FIG. 9) of the planar light-emitting elements.

In this case, the constant-current power supplies 21a through 24a and 21b through 24b are aligned in the longitudinal direction of the planar light-emitting elements. Likewise, the constant-current power supplies 21c through 24c and 21d through 24d are aligned in the short direction of the planar light-emitting elements.

In the example case described in this embodiment, the wiring substrates 32A, 32B, 32C, and 32D are disposed on the principal surface 31a of the base unit on which the planar light-emitting elements are held. However, the embodiment is not limited to that, and the wiring substrates 32A, 32B, 32C, and 32D may be disposed on the principal surface 31b on the opposite side of the base unit from the principal surface 31a. As described above, when seen from the normal direction of the principal surface 30a of the holding member 30 on which the planar light-emitting elements 10A, 10B, 10C, and 10D are held, the constant-current power supplies 21a through 24a, 21b through 24b, 21c through 24c, and 21d through 24d should be positioned to overlap the portions of the no-light emitting portion R1 surrounding the planar light-emitting elements, except for the gaps R2 between the planar light-emitting elements adjacent to each other.

### Fourth Embodiment

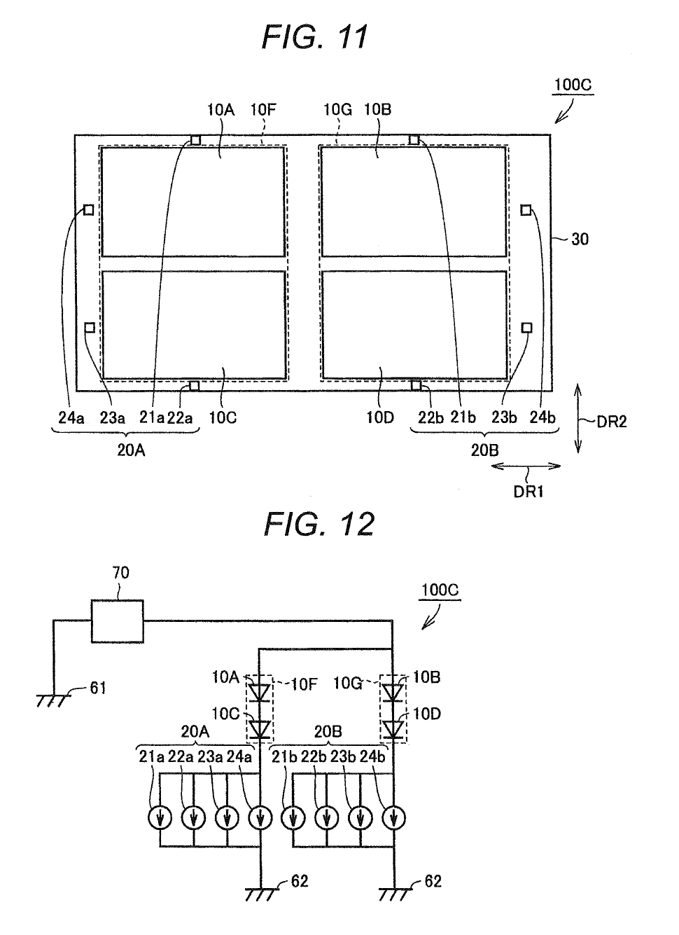

FIG. 11 is a schematic plan view of a light emitting module according to this embodiment. FIG. 12 is a circuit diagram showing the circuit configuration of the light emitting module shown in FIG. 11. Referring now to FIGS. 11 and 12, the light emitting module 100C according to this embodiment is described.

As shown in FIGS. 11 and 12, the light emitting module 100C according to this embodiment differs from the light emitting module 100 according to the first embodiment in the number and the layout of constant-current power supplies, and in the circuit configuration. The other aspects are substantially the same.

The light emitting module 100C includes light emitting units 10F and 10G, a power supply 20A including constant-current power supplies 21a through 24a, 20B including constant-current power supplies 21b through 24b, and a holding member 30. The power supplies 20A and 20B supply constant current to the light emitting units 10F and 10G.

The constant-current power supplies 21a through 24a and 21b through 24b are scattered in a no-light emitting portion surrounding a planar light-emitting element 10A, a planar light-emitting element 10B, a planar light-emitting element 10C, and a planar light-emitting element 10D. The constant-current power supplies 21a through 24a and 21b through 24b are preferably disposed in portions of the no-light emitting portion, except for the gaps between the planar light-emitting elements adjacent to each other. It should be noted that the constant-current power supplies 21a through 24a and 21b through 24b can be modified as appropriate.

In the light emitting module 100C, the light emitting units 10F and 10G are connected to a voltage source 70. The light emitting units 10F and 10G are connected in parallel to each other. The light emitting unit 10F is a string formed with the planar light-emitting elements 10A and 10C connected in series. The light emitting unit 10G is a string formed with the planar light-emitting elements 10B and 10D connected in series.

The power supplies 20A and 20B are connected in series to the light emitting units 10F and 10G. In the respective power supplies 20A and 20B, the constant-current power supplies 21a through 24a and 21b through 24b are connected in parallel.

As described above, in a case where the light emitting units 10F and 10G are formed with strings in which planar light-emitting elements are connected in series, the power supplies including the constant-current power supplies that are connected in parallel and are scattered are connected in series to the light emitting units 10F and 10G, so that the load on each of the constant-current power supplies 21a through 24a and 21b through 24b can be reduced. As a result, this embodiment can also achieve substantially the same effects as those of the first embodiment.

(Modifications)

In each example case described above in the first through fourth embodiments, planar light-emitting elements or light emitting units are connected in parallel in a light emitting module. However, the embodiments are not limited to such examples, and a light emitting module may be formed with a single planar light-emitting element or a single light emitting unit as in the first and second modifications described below.

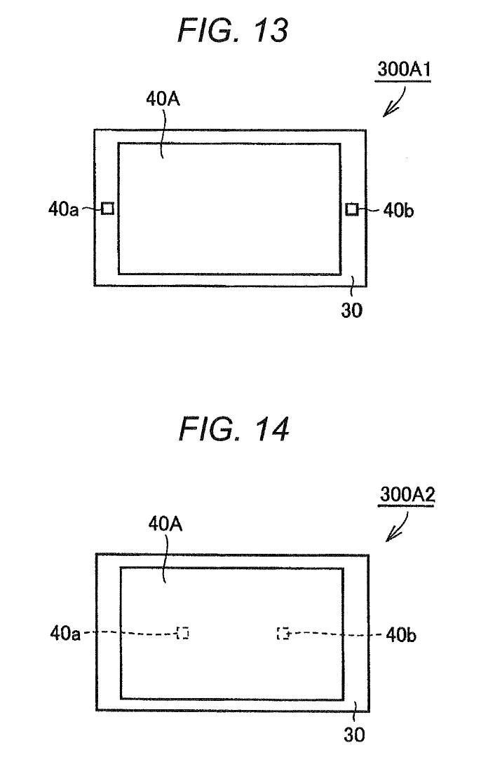

FIGS. 13 and 14 are circuit diagrams showing the circuit configurations of light emitting modules according to first and second modifications. In a light emitting module 300A1 according to the first modification shown in FIG. 13, two constant-current supplies 40a and 40b are disposed on both sides of a single planar light-emitting element 40A.

As shown in FIG. 14, a light emitting module 300A2 according to the second modification differs from the light emitting module 300A1 according to the first modification in the positions of the two constant-current supplies 40a and 40b. In the light emitting module 300A2 according to the second modification, the two constant-current power supplies 40a and 40b are evenly scattered on the principal surface of a holding member 30 on the opposite side from the principal surface of the holding member 30 on which the planar light-emitting element 40A is held.

As constant-current power supplies are scattered around a single planar light-emitting element or a single light emitting unit as in the first and second modifications, heat generation from each constant-current power supply can be reduced. In a case where a single planar light-emitting element is used, temperature variation in the single planar light-emitting element can be reduced. In a case where a single light emitting unit formed with planar light-emitting elements is used, temperature variation among the planar light-emitting elements can be reduced. In either case, the in-plane luminance distribution can be made uniform. It should be noted that the number of planar light-emitting elements and the number of constant-current power supplies can be changed as appropriate, without departing from the scope of the invention.

In the example cases described above in the first through fourth embodiments, a power supply including constant-current power supplies is electrically connected between a planar light-emitting element or a light emitting unit and the ground potential 62. However, embodiments are not limited to such cases, and a power supply including constant-current power supplies may be connected between the voltage source 70 and a planar light-emitting element or a light emitting unit.

In the example cases described above in the first through fourth embodiments, a planar light-emitting element is formed with an organic EL panel. However, embodiments are not limited to such cases, and a planar light-emitting element may be formed with light emitting diodes (LEDs) and a diffuser panel, or may be formed with a cold-cathode tube or the like.

Although embodiments of the present invention have been described so far, the embodiments disclosed in this specification are merely examples in every aspect, and do not limit the invention. The scope of the present invention is shown by the claims, and it should be understood that equivalents of the claimed inventions and all modifications thereof are incorporated herein.

### REFERENCE SIGNS LIST

10A, 10B, 10C, 10D, 40A Planar light-emitting element

10E Light emitting unit

15 Front surface

16 Back surface

20, 21a, 21b, 21c, 21d, 22a, 22b, 22c, 22d, 23a, 23b, 23c, 23d, 24a, 24b, 24c, 24d, 40a, 40b Constant-current power supply 20A, 20B, 20C, 20D Power supply

30 Holding member

30a, 30b Principal surface

31 Base unit

31a, 31b Principal surface

32A, 32B, 32C, 32D Wiring substrate

61, 62 Ground potential

70 Voltage source

100, 100A, 100B, 100C, 200, 300A1, 300A2 Light emitting module

1. A light emitting module comprising:
a light emitting unit including a planar light-emitting element; and
a power supply configured to supply constant current to the light emitting unit, the power supply being connected in series to the light emitting unit, wherein
the power supply includes at least two constant-current power supplies, and
the at least two constant-current power supplies are connected in parallel.

2. The light emitting module according to claim 1, wherein
the light emitting unit includes a plurality of the planar light-emitting elements, and
the planar light-emitting elements are connected in series.

3. The light emitting module according to claim 1, comprising
a plurality of the light emitting units, wherein
the light emitting units are connected in parallel.

4. The light emitting module according to claim 1, further comprising
a holding member configured to hold the planar light-emitting element, wherein
the power supply is disposed on the holding member.

5. The light emitting module according to claim 4, wherein, when seen from a normal direction of a principal surface of the holding member on which the planar light-emitting element is held, the constant-current power supplies are positioned to overlap a no-light emitting portion surrounding the planar light-emitting element.

6. The light emitting module according to claim 4, wherein the constant-current power supplies are scattered around the planar light-emitting element.

7. The light emitting module according to claim 4, wherein, on a principal surface of the holding member on the opposite side from a principal surface of the holding member on which the planar light-emitting element is held, the constant-current power supplies are disposed in portions on the opposite side from the planar light-emitting element.

8. The light emitting module according to claim 7, wherein the constant-current power supplies are scattered on the principal surface of the holding member.

9. The light emitting module according to claim 4, wherein, when seen from a normal direction of a principal surface of the holding member on which the planar light-emitting elements are held, the constant-current power supplies are positioned to overlap portions of the no-light emitting portion surrounding the plurality of the planar light-emitting elements, the portions excluding a gap between the planar light-emitting elements adjacent to each other.

10. The light emitting module according to claim 9, wherein
the holding member includes a base unit holding the planar light-emitting elements, and a wiring substrate disposed on a principal surface of the base unit,
when seen from a normal direction of the principal surface of the holding member on which the planar light-emitting elements are held, the wiring substrate is disposed in a portion of the no-light emitting portion surrounding the plurality of the planar light-emitting elements, the portion excluding a gap between the planar light-emitting elements adjacent to each other, and
the constant-current power supplies are disposed on the wiring substrate.

11. The light emitting module according to claim 1, wherein the planar light-emitting element is an organic EL.

12. The light emitting module according to claim 2, comprising
a plurality of the light emitting units, wherein
the light emitting units are connected in parallel.

13. The light emitting module according to claim 2, further comprising
a holding member configured to hold the planar light-emitting element, wherein
the power supply is disposed on the holding member.

14. The light emitting module according to claim 2, wherein the planar light-emitting element is an organic EL.

15. The light emitting module according to claim 3, wherein the planar light-emitting element is an organic EL.

16. The light emitting module according to claim 4, wherein the planar light-emitting element is an organic EL.

17. The light emitting module according to claim 5, wherein the planar light-emitting element is an organic EL.

18. The light emitting module according to claim 6, wherein the planar light-emitting element is an organic EL.

19. The light emitting module according to claim 7, wherein the planar light-emitting element is an organic EL.

20. The light emitting module according to claim 8, wherein the planar light-emitting element is an organic EL.
